(19) United States
(12) Patent Application Publication
(10) Pub. No.: US 2026/0194894 A1
(43) Pub. Date: Jul. 9, 2026

(54) SYSTEM AND METHOD TO MONITOR AN EQUIPMENT BY RECONSTRUCTING UNCONTROLLABLE VARIABLES IN AN AUTOENCODER

(71) Applicant: UPTIMEAI TECH PRIVATE LIMITED, BENGALURU (IN)

(72) Inventors: CHINTADA ABHILASH, VISAKHAPATNAM (IN); JAGADISH GATTU, SAN RAMON, CA (US); VAMSI YALAMANCHILI, BENGALURU (IN); AMAN KUMAR RAJ, DIST- GODDA (IN)

(21) Appl. No.: 19/430,659

(22) Filed: Dec. 23, 2025

(30) Foreign Application Priority Data
Jan. 3, 2025 (IN) 202541000838

(51) Int. Cl. G05B 23/02; G06N 3/0455; G06N 3/08

(52) U.S. Cl. CPC G05B 23/0254; G06N 3/0455; G06N 3/08

(57) ABSTRACT

A system 100 to monitor an equipment by reconstruction uncontrollable variables in an autoencoder is disclosed. A receiving module 120 receives data from sensors and splits the data into controllable and uncontrollable variables. An analysing module 125 is trained with an autoencoder to pass the controllable variables and uncontrollable variables into a first encoder and a second encoder respectively. The outputs from the said encoders are merged to learn the correlation between the plurality of controllable variables and the uncontrollable variables by a decoder. A detection module 130 identifies similar patterns between the plurality of controllable variables and the uncontrollable variables thereby ensuring an ability to capture nuanced similarities across the entire data. Further, a prediction module 135 predicts a plurality of values based on the correlation thereby reconstructing the uncontrollable variables that are vital to determine a status of the equipment.

### EARLIEST PRIORITY DATE

This Application claims priority from a complete patent application filed in India having Patent Application No. 202541000838, filed on 03 day of January 2025, and titled “A SYSTEM AND METHOD TO MONITOR AN EQUIPMENT BY RECONSTRUCTING UNCONTROLLABLE VARIABLES IN AN AUTOENCODER”.

### FIELD OF INVENTION

Embodiments of the present disclosure relate to the field of monitoring industrial equipment and more particularly to a system and method to monitor an equipment by reconstructing uncontrollable variables in an autoencoder.

### BACKGROUND

An autoencoder is a type of artificial neural network designed to learn compressed representations of input data by reducing it to its essential features and then reconstructing the original input from that compressed form. The two primary applications of autoencoders are dimensionality reduction and information retrieval. However, autoencoders often struggle to reconstruct data that falls outside the range they were trained on, leading to limitations in their ability to generalize effectively. This rigidity in reconstruction hampers their performance, particularly when encountering unexplored or unseen data. As a result, the network's capacity to make accurate predictions in real-world scenarios is limited.

For instance, in industrial equipment monitoring, the accuracy of a model is heavily influenced by patterns in independent variables, such as ambient temperature, which are closely linked to other temperature-related readings. However, training the model across the full temperature range poses a challenge because some equipment shuts down during peak summer months. This exclusion of peak summer data leads to inaccurate predictions for highly correlated temperature tags within that specific range.

Hence, there is a need for an improved system and method to monitor an equipment by reconstructing uncontrollable variables in an autoencoder which addresses the aforementioned issue(s).

### OBJECTIVE OF THE INVENTION

An objective of the present invention is to utilize a dual-path mechanism for feature propagation. In the first pathway, all features pass through, capturing the overall context. Simultaneously, in the second pathway, features of interest are selectively guided through, enhancing the model's focus on specific elements.

Another objective of the present invention is to provide a pattern-based similarity detection. The autoencoder intelligently broadens its attention to encompass all tags exhibiting a similar pattern thereby enhancing the ability to capture nuanced similarities across the entire dataset.

### BRIEF DESCRIPTION

In accordance with an embodiment of the present disclosure, a system to monitor an equipment by reconstructing uncontrollable variables in an autoencoder is provided. The system includes a processing subsystem hosted on a server, wherein the processing subsystem is configured to execute on a network to control bidirectional communications among a plurality of modules. The system includes a receiving module configured to receive data from a plurality of sensors embedded in the equipment. The receiving module is also configured to split the received data into a plurality of controllable variables and a plurality of uncontrollable variables defined by an operator of the equipment. Further, the system includes an analysing module operatively coupled to the receiving module wherein the analysing module trained with an autoencoder. The analysing module is configured to pass the plurality of controllable variables and the plurality of uncontrollable variables into a first encoder and a second encoder respectively thereby establishing a dual-path mechanism for feature propagation. Additionally, the analysing module is configured to merge a plurality of outputs obtained from the said encoders. Further, the analysing module is configured to learn the correlation between the plurality of controllable variables and the plurality of uncontrollable variables by a decoder. The system also includes a detection module operatively coupled to the analysing module wherein the detection module is configured to identify similar patterns between the plurality of controllable variables and the plurality of uncontrollable variables thereby ensuring an ability to capture nuanced similarities across the entire data. The system includes a prediction module operatively coupled to the detection module wherein the prediction module is configured to predict a plurality of values based on the correlation thereby reconstructing the plurality of uncontrollable variables that are vital to determine a status of the equipment.

In accordance with another embodiment of the present disclosure, a method to monitor an equipment by reconstructing uncontrollable variables in an autoencoder is provided. The method includes receiving, by a receiving module, data from a plurality of sensors embedded in the equipment. The method includes splitting, by the receiving module, the received data into a plurality of controllable variables and a plurality of uncontrollable variables defined by an operator of the equipment. The method includes passing, by an analysing module, the plurality of controllable variables and the plurality of uncontrollable variables into a first encoder and a second encoder respectively thereby establishing a dual-path mechanism for feature propagation. The method includes merging, by the analysing module, a plurality of outputs obtained from the said encoders. The method includes learning, by the analysing module, the correlation between the plurality of controllable variables and the plurality of uncontrollable variables by a decoder. The method includes identifying, by a detection module, similar patterns between the plurality of controllable variables and the plurality of uncontrollable variables thereby ensuring an ability to capture nuanced similarities across the entire data. The method includes predicting, by a prediction module, a plurality of values based on the correlation thereby reconstructing the plurality of uncontrollable variables that are vital to determine a status of the equipment.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF THE DRAWINGS

The disclosure will be described and explained with additional specificity and detail with the accompanying figures in which:

FIG. 1 is a block diagram representation of a system to monitor an equipment by reconstructing uncontrollable variables in an autoencoder, in accordance with an embodiment of the present disclosure;

FIG. 2 is a model architecture of a system to monitor an equipment by reconstructing uncontrollable variables in an autoencoder in accordance with an embodiment of the present disclosure;

FIG. 3 is a block diagram of a computer or a server in accordance with an embodiment of the present disclosure; and

FIG. 4 illustrates a flow chart representing the steps involved in a method to monitor an equipment by reconstructing uncontrollable variables in an autoencoder in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or subsystems or elements or structures or components preceded by "comprises... a" does not, without more constraints, preclude the existence of other devices, sub-systems, elements, structures, components, additional devices, additional sub-systems, additional elements, additional structures or additional components. Appearances of the phrase "in an embodiment", "in another embodiment" and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

In accordance with an embodiment of the present disclosure, a system to monitor an equipment by reconstructing uncontrollable variables in an autoencoder is provided. The system includes a processing subsystem hosted on a server, wherein the processing subsystem is configured to execute on a network to control bidirectional communications among a plurality of modules. The system includes a receiving module configured to receive data from a plurality of sensors embedded in the equipment. The receiving module is also configured to split the received data into a plurality of controllable variables and a plurality of uncontrollable variables defined by an operator of the equipment. Further, the system includes an analysing module operatively coupled to the receiving module wherein the analysing module trained with an autoencoder. The analysing module is configured to pass the plurality of controllable variables and the plurality of uncontrollable variables into a first encoder and a second encoder respectively thereby establishing a dual-path mechanism for feature propagation. Additionally, the analysing module is configured to merge a plurality of outputs obtained from the said encoders. Further, the analysing module is configured to learn the correlation between the plurality of controllable variables and the plurality of uncontrollable variables by a decoder. The system also includes a detection module operatively coupled to the analysing module wherein the detection module is configured to identify similar patterns between the plurality of controllable variables and the plurality of uncontrollable variables thereby ensuring an ability to capture nuanced similarities across the entire data. The system includes a prediction module operatively coupled to the detection module wherein the prediction module is configured to predict a plurality of values based on the correlation thereby reconstructing the plurality of uncontrollable variables that are vital to determine a status of the equipment.

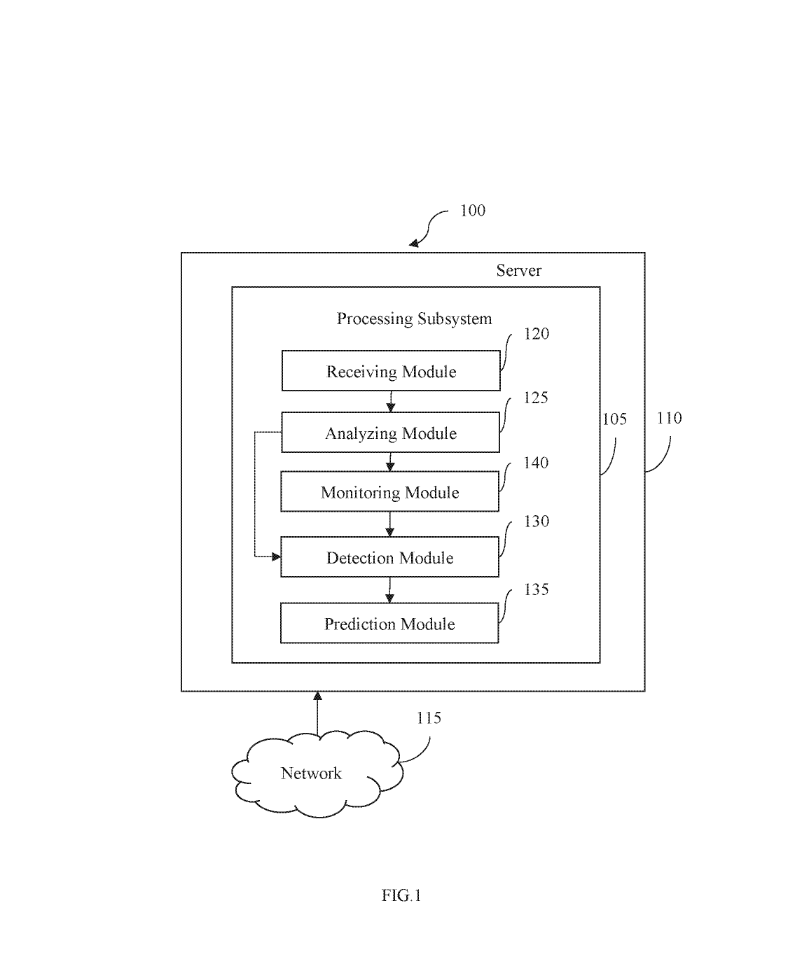

FIG. 1 is a block diagram representation of a system to monitor an equipment by reconstructing uncontrollable variables in an autoencoder, in accordance with an embodiment of the present disclosure. The system 100 includes a processing subsystem 105 hosted on a server 110. In one embodiment, the server 110 may include a cloud server. In another embodiment, the server 110 may include a local server. The processing subsystem 105 is configured to execute on a network 115 to control bidirectional communications among a plurality of modules. In a preferred embodiment, the network 115 may include a Wireless local area network (WLAN) network, a cellular network and a Low-power wide-area (LPWA) network. In one embodiment, the network 115 may also include a wired network such as local area network (LAN), Wi-Fi, Bluetooth, Zigbee, near field communication (NFC), infra-red communication (RFID) or the like. Further, the plurality of modules includes a receiving module, an analysing module, a detection module and a prediction module.

The receiving module 120 is configured to receive data from a plurality of sensors embedded in the equipment. The equipment may include, but is not limited to, motors, pumps, machinery, furnaces, and the like commonly used in industrial manufacturing environments such as refineries, chemical plants, cement factories, metal production facilities, power plants, and the like. The data captured by the plurality of sensors may cover a wide range of operational parameters, including but not limited to fan speed, temperature, pressure, and the like, which are essential for monitoring equipment performance.

Further, the receiving module 120 is configured to split the received data into a plurality of controllable variables and a plurality of uncontrollable variables defined by an operator of the equipment. The plurality of controllable variables refers to variables are under human or system control, which may be modified to optimize performance or response. Examples of the plurality of controllable variables includes but not limited to pressure, fan speed, valve position and the like of the equipment. The plurality of uncontrollable variables are variables that cannot be directly manipulated or controlled by the operator. Examples of the plurality of uncontrollable variables includes but are not limited to ambient temperature, load of the system, humidity levels, wind speed and the like.

Additionally, it is important to note that the operator of the equipment defines which data should be classified as the plurality of controllable variables and which as the plurality of controllable variables. The selection is based on the specific industrial requirements and operational conditions of the operator. This flexibility ensures that the system is adaptable to different industrial environments.

The analysing module 125 is operatively coupled to the receiving module 120 wherein the analysing module 125 trained with an autoencoder. The autoencoder is a type of machine learning model that includes an encoder, which transforms input data into a lower-dimensional or compressed representation by capturing essential features and discarding irrelevant information.

The analysing module 125 is configured to pass the plurality of controllable variables and the plurality of uncontrollable variables into a first encoder and a second encoder respectively thereby establishing a dual-path mechanism for feature propagation. More specifically, the first encoder handles plurality of controllable variables like pressure or fan speed and the like, compressing the data, while the second encoder does the same for the plurality of uncontrollable variables like ambient temperature, load of the system, humidity and the like. The analysing module is configured to merge a plurality of outputs obtained from the said encoders (the first encoder and the second encoder). Further, the analysing module is configured to learn the correlation between the plurality of controllable variables and the plurality of uncontrollable variables by a decoder.

It must be noted that, the machine learning model uses artificial intelligence algorithms. Examples of the artificial intelligence algorithm include, but are not limited to, a Deep Neural Network (DNN), Convolutional Neural Network (CNN), Restricted Boltzmann Machine (RBM), Deep Belief Network (DBN) and Deep Q-Networks.

It must be noted that the machine learning model is a continuous learning model. The system continuously updates its understanding of the relationship between the plurality of controllable variables and the plurality of uncontrollable variables as it receives new data.

In one embodiment, the autoencoder is configured to mitigate a risk of overfitting on broader patterns thereby ensuring that the autoencoder is adaptable to unseen data with similar patterns. In such an embodiment, the autoencoder is configured to understand patterns in uncontrollable variables where reconstruction was crucial on unseen data.

Further, in another embodiment, the autoencoder is trained with an original data region.

In one embodiment, the first encoder passes all the features to retain an overall context of the data thereby preventing contextual information from being lost during feature propagation and the second encoder is configured to pass selective features of interest to understand reasoning behind the predictions.

The processing subsystem 105 also includes a detection module 130 operatively coupled to the analysing module 125 wherein the detection module 130 is configured to identify similar patterns between the plurality of controllable variables and the plurality of uncontrollable variables thereby ensuring an ability to capture nuanced similarities across the entire data.

In one embodiment, the detection module 130 is configured to generate one or more alerts to the operator.

Additionally, the processing subsystem 105 includes a prediction module (135) operatively coupled to the detection module 130 wherein the prediction module 135 is configured to predict a plurality of values based on the correlation thereby reconstructing the plurality of uncontrollable variables that are vital to determine a status of the equipment.

In one embodiment, the plurality of controllable variables that are highly correlated with the plurality of uncontrollable variables exhibit an improvement.

In one embodiment, the processing subsystem 105 includes a monitoring module 140 operatively coupled to the analyzing module 125 wherein the monitoring module 140 is configured to constantly monitor and track the plurality of uncontrolled variables of the autoencoder.

In one embodiment, the system ensures high accuracy in detecting and retaining failures that are recognized as important or approved. Specifically, the model is capable of retaining at least 98.77% of approved failures, thereby maintaining a comprehensive understanding of system anomalies.

Let's consider an example, a pump system used in a chemical processing plant. The system is equipped with the plurality of sensors to monitor key parameters, including ambient temperature, pressure, fan speed, vibrations and the like. The receiving module categorizes these parameters into controllable and uncontrollable variables based on the requirements defined by the operator, and these categorizations are preset in the pump system. The system utilizes the autoencoder to monitor and analyze both controllable and uncontrollable variables. The first encoder processes the controllable variables, while the second encoder handles and compresses the uncontrollable variables. These two sets of compressed data are then correlated through a decoder, enabling the system to learn how external environmental factors (uncontrollable variables) influence internal system performance (controllable variables). For instance, suppose there is a sudden spike in ambient temperature (an uncontrollable variable). If the operator indicates that this spike should not impact system performance, the model will treat it as a non-critical event, preventing overfitting to irrelevant environmental data. Conversely, if the operator flags the temperature spike as a potential issue, the model will retain this as a failure mode.

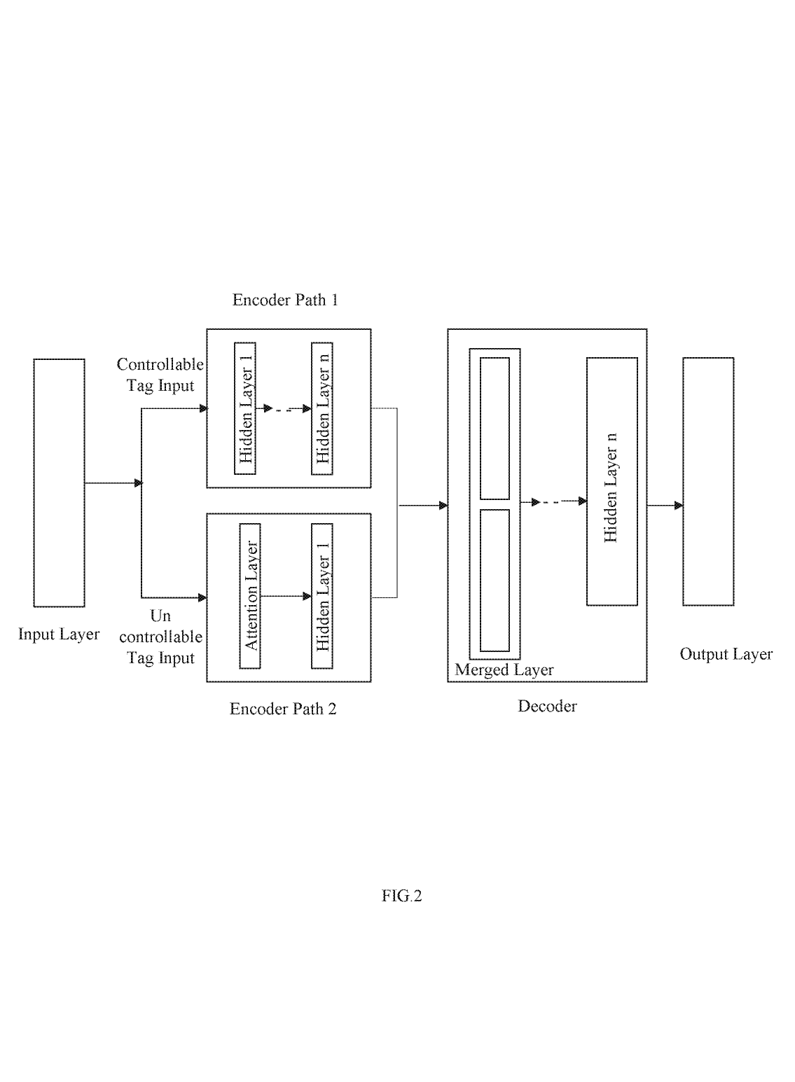

FIG. 2 is a model architecture of a system to monitor an equipment by reconstructing uncontrollable variables in an autoencoder in accordance with an embodiment of the present disclosure. The autoencoder efficiently processes data containing both controllable and uncontrollable tags by separating inputs using a mask. The architecture includes two encoder paths, “encoder path 1” handles controllable tags, which are attributes that users can directly influence or modify. The “encoder path 1” compresses these tags through hidden layers, extracting essential features of the controllable tags effectively and “encoder path 2” focuses on uncontrollable tags, which cannot be directly influenced. The “encoder path 2” uses an attention mechanism to highlight the most relevant features, enabling the model to extract valuable insights from the data. The outputs of the “encoder path 1” and the “encoder path 2” are then combined to form a unified latent representation, which captures the critical characteristics of both controllable and uncontrollable tags. A merged representation is passed to a decoder, which reconstructs the ideal tag values. By leveraging information from the “encoder path 1” and the “encoder path 2”, the decoder ensures the final output is accurate, precise, and contextually aligned with the input.

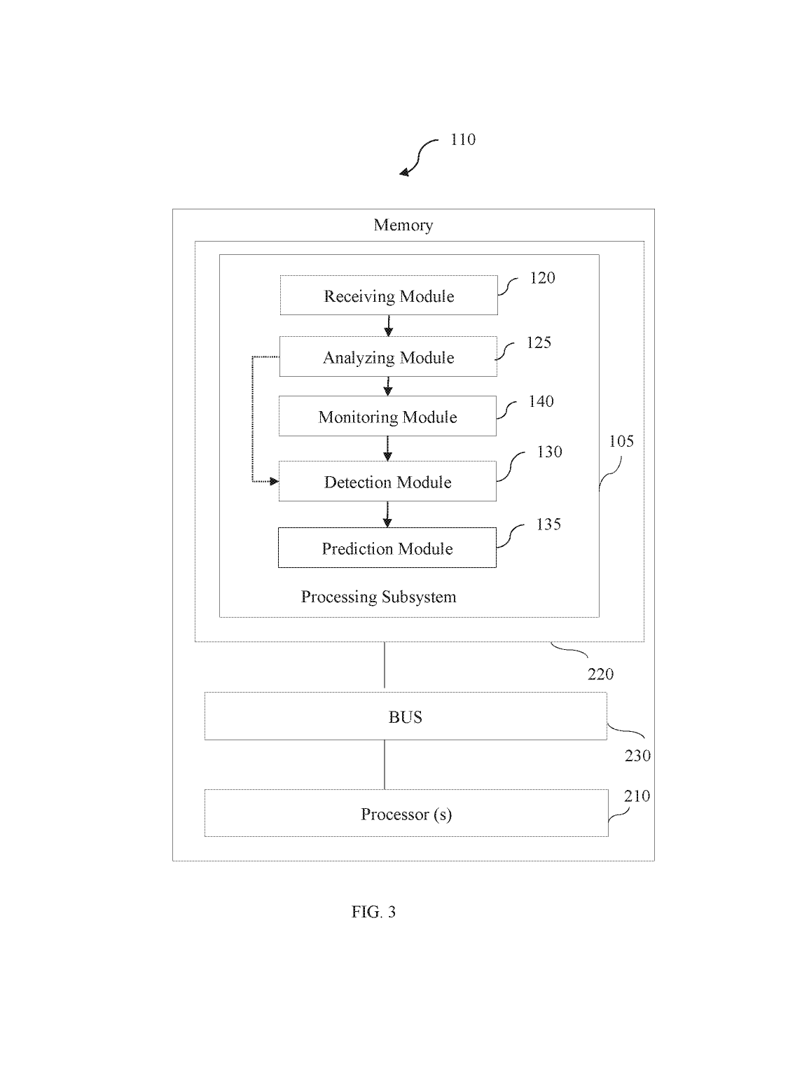

FIG. 3 is a block diagram of a computer or a server 110 in accordance with an embodiment of the present disclosure. The server 110 includes processor(s) 210, and memory 220 operatively coupled to the bus 230. The processor(s) 210, as used herein, means any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a digital signal processor, or any other type of processing circuit, or a combination thereof.

The memory 220 includes several subsystems stored in the form of executable program which instructs the processor 210 to perform the method steps illustrated in FIG. 1. The memory 220 includes a processing subsystem 105 of FIG. 1. The processing subsystem 105 includes a plurality of modules. The plurality of modules includes a receiving module 120, an analysing module 125, a detection module 130, a prediction module 135 and a monitoring module 140.

The receiving module 120 configured to receive data from a plurality of sensors embedded in the equipment. The receiving module 120 is also configured to split the received data into a plurality of controllable variables and a plurality of uncontrollable variables defined by an operator of the equipment. Further, the system 100 includes an analysing module 125 operatively coupled to the receiving module 120 wherein the analysing module trained with an autoencoder. The analysing module 125 is configured to pass the plurality of controllable variables and the plurality of uncontrollable variables into a first encoder and a second encoder respectively thereby establishing a dual-path mechanism for feature propagation. Additionally, the analysing module 125 is configured to merge a plurality of outputs obtained from the said encoders. Further, the analysing module 125 is configured to learn the correlation between the plurality of controllable variables and the plurality of uncontrollable variables by a decoder. The system 100 also includes a detection module 130 operatively coupled to the analysing module 125 wherein the detection module 130 is configured to identify similar patterns between the plurality of controllable variables and the plurality of uncontrollable variables thereby ensuring an ability to capture nuanced similarities across the entire data. The system 100 includes a prediction module 135 operatively coupled to the detection module 130 wherein the prediction module 135 is configured to predict a plurality of values based on the correlation thereby reconstructing the plurality of uncontrollable variables that are vital to determine a status of the equipment.

The bus 230 as used herein refers to be internal memory channels or computer network that is used to connect computer components and transfer data between them. The bus 230 includes a serial bus or a parallel bus, wherein the serial bus transmits data in bit-serial format and the parallel bus transmits data across multiple wires. The bus 230 as used herein, may include but not limited to, a system bus, an internal bus, an external bus, an expansion bus, a frontside bus, a backside bus and the like.

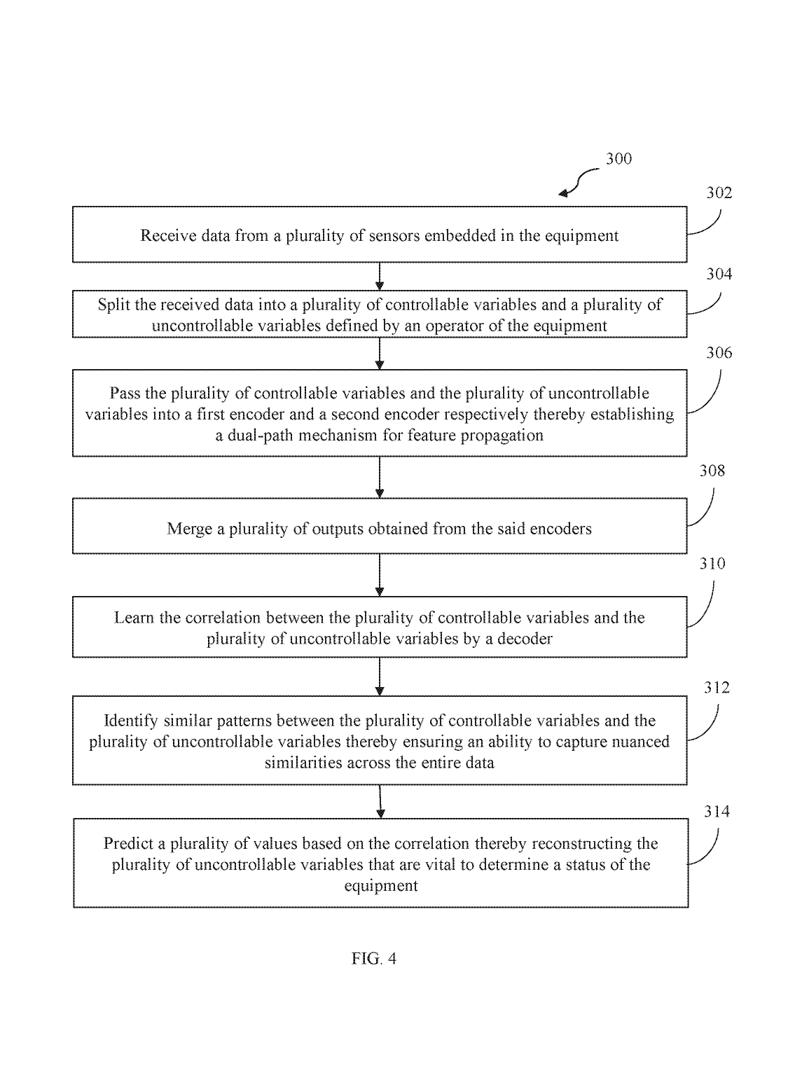

FIG. 4 illustrates a flow chart representing the steps involved in a method to monitor an equipment by reconstructing uncontrollable variables in an autoencoder in accordance with an embodiment of the present disclosure. The method includes receiving, by a receiving module, data from a plurality of sensors embedded in the equipment in step 302. The equipment may include, but is not limited to, motors, pumps, machinery, furnaces, and the like commonly used in industrial manufacturing environments such as refineries, chemical plants, cement factories, metal production facilities, power plants, and the like. The data captured by the plurality of sensors may cover a wide range of operational parameters, including but not limited to fan speed, temperature, pressure, and the like, which are essential for monitoring equipment performance.

The method includes splitting, by the receiving module, the received data into a plurality of controllable variables and a plurality of uncontrollable variables defined by an operator of the equipment in step 304. The plurality of controllable variables refers to variables are under human or system control, which may be modified to optimize performance or response. Examples of the plurality of controllable variables includes but not limited to pressure, fan speed, valve position and the like of the equipment. The plurality of uncontrollable variables are variables that cannot be directly manipulated or controlled by the operator. Examples of the plurality of uncontrollable variables includes but are not limited to ambient temperature, load of the system, humidity levels, wind speed and the like.

Additionally, it is important to note that the operator of the equipment defines which data should be classified as the plurality of controllable variables and which as the plurality of controllable variables. The selection is based on the specific industrial requirements and operational conditions of the operator. This flexibility ensures that the system is adaptable to different industrial environments.

The method includes passing, by an analysing module, the plurality of controllable variables and the plurality of uncontrollable variables into a first encoder and a second encoder respectively thereby establishing a dual-path mechanism for feature propagation in step 306. The autoencoder is a type of machine learning model that includes an encoder, which transforms input data into a lower-dimensional or compressed representation by capturing essential features and discarding irrelevant information. More specifically, the first encoder handles plurality of controllable variables like pressure or fan speed and the like, compressing the data, while the second encoder does the same for the plurality of uncontrollable variables like ambient temperature, load of the system, humidity and the like.

The method includes merging, by the analysing module, a plurality of outputs obtained from the said encoders in step 308.

The method includes learning, by the analysing module, the correlation between the plurality of controllable variables and the plurality of uncontrollable variables by a decoder in step 310.

It must be noted that the machine learning model is a continuous learning model. The system continuously updates its understanding of the relationship between the plurality of controllable variables and the plurality of uncontrollable variables as it receives new data.

In one embodiment, the autoencoder is configured to mitigate a risk of overfitting on broader patterns thereby ensuring that the autoencoder is adaptable to unseen data with similar patterns. In such an embodiment, the autoencoder is configured to understand patterns in uncontrollable variables where reconstruction was crucial on unseen data.

Further, in another embodiment, the autoencoder is trained with an original data region.

In one embodiment, the first encoder passes all the features to retain an overall context of the data thereby preventing contextual information from being lost during feature propagation and the second encoder is configured to pass selective features of interest to understand reasoning behind the predictions.

The method includes identifying, by a detection module, similar patterns between the plurality of controllable variables and the plurality of uncontrollable variables thereby ensuring an ability to capture nuanced similarities across the entire data in step 312.

In one embodiment, the detection module is configured to generate one or more alerts to the operator.

The method includes predicting, by a prediction module, a plurality of values based on the correlation thereby reconstructing the plurality of uncontrollable variables that are vital to determine a status of the equipment in step 314.

In one embodiment, the plurality of controllable variables that are highly correlated with the plurality of uncontrollable variables exhibit an improvement.

In one embodiment, the system ensures high accuracy in detecting and retaining failures that are recognized as important or approved. Specifically, the model is capable of retaining at least 98.77% of approved failures, thereby maintaining a comprehensive understanding of system anomalies. The high level of retention contributes to the overall robustness of the model, allowing it to accurately track, identify, and respond to critical issues in the system.

Various embodiments of the present disclosure to monitor an equipment by reconstructing uncontrollable variables in an autoencoder provides several benefits. There is a 99% improvement on reconstruction of independent variables and 33 % improvement on reconstruction of equipment variables. Further, up to 98.77% failures are retained, maintaining a comprehensive understanding of the system anomalies for enhanced model robustness. Additionally, the system is designed as a continuous learning model, allowing it to adapt to new data and evolving operational conditions.

It will be understood by those skilled in the art that the foregoing general description and the following detailed description are exemplary and explanatory of the disclosure and are not intended to be restrictive thereof.

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, the order of processes described herein may be changed and are not limited to the manner described herein. Moreover, the actions of any flow diagram need not be implemented in the order shown; nor do all of the acts need to be necessarily performed. Also, those acts that are not dependent on other acts may be performed in parallel with the other acts. The scope of embodiments is by no means limited by these specific examples.

We claim:

1. A system to monitor an equipment by reconstructing uncontrollable variables in an autoencoder comprising:
characterized in that,
a processing subsystem hosted on a server, wherein the processing subsystem is configured to execute on a network to control bidirectional communications among a plurality of modules comprising:
a receiving module configured to:
receive data from a plurality of sensors embedded in the equipment;
split the received data into a plurality of controllable variables and a plurality of uncontrollable variables defined by an operator of the equipment;
an analysing module operatively coupled to the receiving module wherein the analysing module is trained with an autoencoder and is configured to:
pass the plurality of controllable variables and the plurality of uncontrollable variables into a first encoder and a second encoder respectively thereby establishing a dual-path mechanism for feature propagation;
merge a plurality of outputs obtained from the said encoders; and
learn the correlation between the plurality of controllable variables and the plurality of uncontrollable variables by a decoder;
a detection module operatively coupled to the analysing module wherein the detection module is configured to identify similar patterns between the plurality of controllable variables and the plurality of uncontrollable variables thereby ensuring an ability to capture nuanced similarities across the entire data; and
a prediction module operatively coupled to the detection module wherein the prediction module is configured to predict a plurality of values based on the correlation thereby reconstructing the plurality of uncontrollable variables that are vital to determine a status of the equipment.

2. The system as claimed in claim 1, comprises a monitoring module operatively coupled to the analysing module wherein the monitoring module is configured to constantly monitor and track the plurality of uncontrolled variables of the autoencoder.

3. The system as claimed in claim 1, wherein the autoencoder is configured to mitigate a risk of overfitting on broader patterns thereby ensuring that the autoencoder is adaptable to unseen data with similar patterns.

4. The system as claimed in claim 1, wherein the first encoder passes all the features to retain an overall context of the data thereby preventing contextual information from being lost during feature propagation and the second encoder is configured to pass selective features of interest to understand reasoning behind the predictions.

5. The system as claimed in claim 1, wherein the autoencoder is configured to understand patterns in uncontrollable variables where reconstruction was crucial on unseen data.

6. The system as claimed in claim 1, wherein the autoencoder is trained with an original data region.

7. The system as claimed in claim 1, wherein the detection module is configured to generate one or more alerts to the operator.

8. The system as claimed in claim 1, wherein the plurality of controllable variables that are highly correlated with the plurality of uncontrollable variables exhibit an improvement.

9. A method to monitor an equipment by reconstructing uncontrollable variables in an autoencoder comprising:
characterized in that,
receiving, by a receiving module, data from a plurality of sensors embedded in the equipment;
splitting, by the receiving module, the received data into a plurality of controllable variables and a plurality of uncontrollable variables defined by an operator of the equipment;
passing, by an analysing module, the plurality of controllable variables and the plurality of uncontrollable variables into a first encoder and a second encoder respectively thereby establishing a dual-path mechanism for feature propagation;
merging, by the analysing module, a plurality of outputs obtained from the said encoders;
learning, by the analysing module, the correlation between the plurality of controllable variables and the plurality of uncontrollable variables by a decoder;
identifying, by a detection module, similar patterns between the plurality of controllable variables and the plurality of uncontrollable variables thereby ensuring an ability to capture nuanced similarities across the entire data; and
predicting, by a prediction module, a plurality of values based on the correlation thereby reconstructing the plurality of uncontrollable variables that are vital to determine a status of the equipment.
